(19) United States
(12) Patent Application Publication
(10) Pub. No.: US 2025/0346242 A1
(43) Pub. Date: Nov. 13, 2025

(54) VEHICLE CONTROL SYSTEM THAT LIMITS THE DRIVER'S DRIVING BEHAVIOR AND VEHICLE CONTROL METHOD USING THE SAME

(71) Applicant: ELECTRONICS AND TELECOMMUNICATIONS RESEARCH INSTITUTE, Daejeon (KR)

(72) Inventors: Kyung Bok Sung, Daejeon (KR); Kyoung-Wook Min, Daejeon (KR); Jeong-Woo Lee, Daejeon (KR); Jeong Dan Choi, Daejeon (KR)

(21) Appl. No.: 18/978,117

(22) Filed: Dec. 12, 2024

(30) Foreign Application Priority Data
May 7, 2024 (KR) 10-2024-0060118

(51) Int. Cl. B60W 50/10; B60W 60/00

(52) U.S. Cl. CPC B60W 50/10; B60W 60/005; B60W 2540/30

(57) ABSTRACT

Disclosed are a vehicle control system that limits a driver's driving behavior and a vehicle control method using the same. The vehicle control system that limits a driver's driving behavior includes an input interface device configured to receive a driver's control input, memory in which a program that recognizes the driver's control input and that determines whether to incorporate the results of the recognition into vehicle control has been stored, and a processor configured to execute the program. The processor controls the driver's control input, which belongs to first classification, to be not incorporated into the vehicle control without any change and controls the driver's control input, which belongs to second classification, to be immediately incorporated into the vehicle control based on the results of the recognition.

### CROSS-REFERENCE TO RELATED APPLICATION

This application claims priority from and the benefit of Korean Patent Application No. 10-2024-0060118, filed on May 7, 2024, which is hereby incorporated by reference for all purposes as if set forth herein.

### BACKGROUND

### 1. Technical Field

The present disclosure relates to a vehicle control system that limits a driver's driving behavior and a vehicle control method using the same.

### 2. Description of Related Art

A traffic accident continues to occur due to sudden acceleration attributable to an acceleration mistake during the driving of a novice driver or a mistake during the driving of an elderly driver.

According to a conventional technology, as the autonomous driving technology is gradually applied to commercial vehicles, some accidents can be prevented, but the autonomous driving technology has the limit of not presenting a detailed solution for preventing a traffic accident that occurs due to a driver's mistake or carelessness.

### SUMMARY

Various embodiments are directed to providing a system and method which partially limit a person's driving behavior in a vehicle which may be driven by a person and control the vehicle to travel through autonomous driving.

A vehicle control system that limits a driver's driving behavior according to an embodiment of the present disclosure includes an input interface device configured to receive a driver's control input, memory in which a program that recognizes the driver's control input and that determines whether to incorporate the results of the recognition into vehicle control has been stored, and a processor configured to execute the program. The processor controls the driver's control input, which belongs to first classification, to be not incorporated into the vehicle control without any change and controls the driver's control input, which belongs to second classification, to be immediately incorporated into the vehicle control based on the results of the recognition.

The processor incorporates a control input for a deceleration input, which belongs to the second classification, into the vehicle control.

The processor executes an autonomous driving function with respect to a control function related to the driver's control input, which belongs to the first classification, and controls manual driving to be performed with respect to the driver's control input, which belongs to the second classification.

The input interface device receives surrounding environment information, driver behavior detection information, driving information, and a driver control input value.

The processor generates input integration data by integrating the data received by the input interface device and detects the driver's driving intention.

The processor performs learning based on a driving path prediction value and a driver's driving intention prediction value and updates driver's driving intention detection logic.

The processor performs driving control by mixing the driver's control input and a control calculation value for autonomous driving.

The processor incorporates the driver's control input, which belongs to the first classification, into the vehicle control when the input interface device receives an input value for a manual driving command.

A vehicle control method of limiting a driver's driving behavior according to an embodiment of the present disclosure includes steps of (a) receiving and classifying a driver's control input and (b) incorporating the driver's control input into manual driving or performing autonomous driving by disregarding the driver's control input based on the results of the classification in the step (a).

The step (a) includes additionally collecting driving information and surrounding environment information in addition to the driver's control input.

The step (b) includes generating input integration data by integrating the information collected in the step (a) and detecting the driver's driving intention.

The step (b) includes performing learning based on driving path prediction results and the results of the detection of the driver's driving intention and updating driver's driving intention detection logic.

The step (b) includes disregarding the driver's control input for an acceleration input and incorporating the driver's control input for a deceleration input into driving.

The step (b) includes incorporating the driver's control input for the acceleration input into the driving when receiving a separate command for manual driving from a user.

The step (b) includes performing driving control by mixing the driver's control input and a control calculation value for autonomous driving.

A vehicle apparatus according to an embodiment of the present disclosure includes an input module configured to receive surrounding environment recognition information, driver behavior detection information, driving information, and driver control input information and a vehicle control system configured to control autonomous driving and manual driving based on the information received by the input module and to limit a driver's driving behavior based on a previously classified category.

The vehicle control system incorporates the driver's control input for deceleration control into driving without any change and controls the autonomous driving by disregarding the driver's control input for acceleration control.

The vehicle control system incorporates the acceleration control into the driving when receiving a separate user command for the manual driving.

The vehicle control system detects the driver's driving intention based on the information received by the input module, performs learning by using driving path prediction results and driver's driving intention prediction results, and updates driver's driving intention detection logic.

The vehicle control system performs driving control by mixing the driver's control input and a control calculation value for the autonomous driving.

According to an embodiment of the present disclosure, it is possible to prevent a sudden acceleration situation that occurs due to a driver's confusion because a driver's direct driving behavior is partially limited and the acceleration of a vehicle is autonomously performed according to a situation. It is possible to dually secure the safety of driving by wholly providing a driver with the right to control deceleration.

According to an embodiment of the present disclosure, it is possible to clearly set the scope of responsibilities of an automobile manufacturer for autonomous driving because a matter of responsibility between a driver and the automobile manufacturer is made clear by clarifying the cause of an accident of a traffic accident and a matter of responsibility thereof in a situation in which autonomous driving and manual driving are mixed before a full autonomous driving level is reached.

It is possible to reduce a traffic accident that occurs due to a driver's inexperienced or mistaken driving because an automobile manufacturer can positively apply a technique within the scope of responsibilities and a driver's acceleration control during vehicle driving is basically disregarded without being incorporated into the vehicle driving.

According to an embodiment of the present disclosure, it is possible to prevent a driving stop according to menu-over for accident avoidance, such as a stop on the shoulder, and to support a vehicle so that the vehicle can continuously travel by presenting countermeasures for solving impossible autonomous driving when autonomous driving is impossible in a situation in which safe autonomous driving has not been perfectly performed. Furthermore, the present disclosure can contribute to the leading of the autonomous driving technology because the present disclosure may be used before a perfect autonomous driving technology is introduced.

Effects of the present disclosure which may be obtained in the present disclosure are not limited to the aforementioned effects, and other effects not described above may be evidently understood by a person having ordinary knowledge in the art to which the present disclosure pertains from the following description.

### BRIEF DESCRIPTION OF THE DRAWINGS

FIG. 1 illustrates a vehicle control system and a plurality of input modules according to an embodiment of the present disclosure.

FIG. 2 illustrates input integration data according to an embodiment of the present disclosure.

FIG. 3 illustrates input integration data and the results of the detection of driver's driving intention according to an embodiment of the present disclosure.

FIG. 4 illustrates a driver's driving intention detection unit according to an embodiment of the present disclosure.

FIG. 5 illustrates an autonomous driving/manual driving sequence according to an embodiment of the present disclosure.

FIG. 6 illustrates a vehicle control system according to another embodiment of the present disclosure.

FIG. 7 is a block diagram illustrating a computer system for implementing a method according to an embodiment of the present disclosure.

### DETAILED DESCRIPTION

The aforementioned object, other objects, advantages, and characteristics of the present disclosure and a method for achieving the objects, advantages, and characteristics will become clear with reference to embodiments to be described in detail along with the accompanying drawings.

However, the present disclosure is not limited to embodiments disclosed hereinafter, but may be implemented in various different forms. The following embodiments are merely provided to easily notify a person having ordinary knowledge in the art to which the present disclosure pertains of the objects, constructions, and effects of the present disclosure. The scope of rights of the present disclosure is defined by the writing of the claims.

Terms used in this specification are used to describe embodiments and are not intended to limit the present disclosure. In this specification, an expression of the singular number includes an expression of the plural number unless clearly defined otherwise in the context. The term “comprises” and/or “comprising” used in this specification does not exclude the presence or addition of one or more other components, steps, operations and/or components in addition to mentioned components, steps, operations and/or components.

An embodiment of the present disclosure proposes an autonomous driving system which prevents a traffic accident attributable to a driver's mistake or carelessness by using the autonomous driving technology in a vehicle that can be driven by a driver on board. That is, an embodiment of the present disclosure proposes a system which prevents an accident by using the autonomous driving technology in a situation in which a driver can control a vehicle in the driver's seat except a vehicle in which a driver's seat is not present or a situation in which a driver is not seated in the driver's seat.

An embodiment of the present disclosure prevents the occurrence of a traffic accident attributable to a driver's mistake by limiting a person's driving behavior (or rights to driving) in a vehicle which can be driven by a person. It is almost impossible for vehicle manufacturers to develop and commercialize perfect autonomous vehicles which can be driven in all situations. According to an embodiment of the present disclosure, a driver's rights to driving are partially limited, but the driver's manual driving is made possible. Accordingly, it is possible to support some more leeway for technology development and commercialization because a situation in which driving is impossible through autonomous driving can be solved through a driver's manual driving. From a point of view of a vehicle manufacturer (or autonomous vehicle manufacturer), the rights to acceleration is assigned to a system, but the rights to all of basic manipulations are assigned to a driver. Accordingly, the vehicle manufacturer can have some leeway in the manufacturing and commercialization of autonomous vehicles because the vehicle manufacturer can take a portion of responsibilities for an accident without taking all of the responsibilities and avoid some of the responsibilities, when the accident occurs.

According to an embodiment of the present disclosure, it is made clear that a driver is responsible for a traffic accident regardless of autonomous driving. It is possible to prevent the occurrence of a traffic accident attributable to a driver's mistake (e.g., a case in which a driver steps on an acceleration pedal at the moment when the driver should steps on a brake pedal because the driver confuses the acceleration pedal with the brake pedal. It is possible to advance the spread of the autonomous driving technology by making clear responsibilities for an accident during autonomous driving.

According to an embodiment of the present disclosure, a vehicle control apparatus identifies a person's driving intention by analyzing a person's driving behavior and controls a vehicle to automatically perform proper driving based on the identified driving intention and the results of the recognition of a surrounding environment. The rights to driving control are changed so that manual driving is performed, if necessary or a driver's preference, while autonomous driving is performed. Autonomous driving is performed again if the driver does not perform manual driving.

An embodiment of the present disclosure proposes a driver's manipulation (or driving behavior) for acceleration. A driver's acceleration manipulation is limited, and acceleration is autonomously performed in accordance with situations, such as a driver's transmission, a brake, a turn indicator, or an emergency light manipulation. Furthermore, in the case of a driver's deceleration manipulation, a brake immediately operates without being limited to a separate driving behavior. As a vehicle autonomously performs acceleration, the possibility of a sudden manipulation of an acceleration pedal attributable to an elderly person and novice driver's mistake can be reduced, and dangerous driving and the obstruction of a traffic flow according to a sudden manipulation of the acceleration pedal can be reduced.

A driver can directly perform driving if necessary. Accordingly, a driver can actively perform driving and solve a problem occurring during driving even in a special situation in which a full autonomous vehicle cannot travel because the driver does not ride on a vehicle on which the driver does not have the driving authority like a full autonomous vehicle. The possibility of an accident attributable to a driver's manipulation mistake can be reduced because the driver can transfer the acceleration authority to a system or has limited acceleration authority.

An embodiment of the present disclosure proposes a system that limits a driver's manual driving and that autonomously accelerates, decelerates, and steers a vehicle in accordance with a situation. The acceleration authority is granted to the system while the driver retains control over other functions (e.g., a brake, a steering wheel, a turn indicator, and an emergency light) without any change except for acceleration.

An object of the present disclosure is to actively utilize autonomous driving technology to prevent accidents. To achieve this, the driver's manual control is limited, and autonomous driving technology is actively employed. However, if the driver's manual control is entirely restricted based solely on trust in autonomous driving technology, the vehicle will be unable to respond to special situations where autonomous driving alone cannot handle the driving. Therefore, while limiting the driver's manual control and actively utilizing autonomous driving technology, the system is designed to allow manual driving in special situations. To this end, an embodiment of the present disclosure includes a function that permits a driver's acceleration control through a separate driver input (e.g., an acceleration control permission button).

Hereinafter, methods for the limit of a driver's rights to control, the identification of driver's driving intention, and a smooth change of rights to control according to embodiments of the present disclosure are described.

According to an embodiment of the present disclosure, a driver's control input is not incorporated into vehicle control without any change because the driver's driving input is limited, but the driver's steering and deceleration inputs (or brake input) are immediately incorporated into the vehicle control. A vehicle driving sequence is changed so that the vehicle is autonomously driven without a separate autonomous driving input based on the results of the identification of a driver's driving intention. When a driver's control input is present, the control input is incorporated into vehicle driving and the vehicle continuously performs autonomous driving.

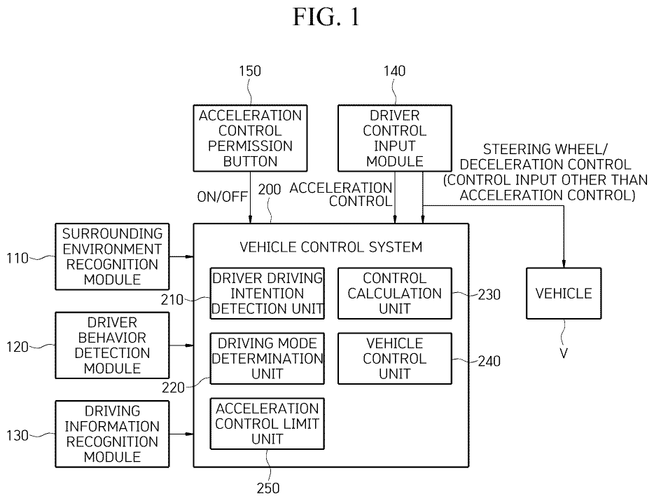

FIG. 1 illustrates a vehicle control system and a plurality of input modules according to an embodiment of the present disclosure.

A vehicle control system 200 according to an embodiment of the present disclosure operates by being connected between a driver and a vehicle V. The vehicle includes all of moving bodies on which a person can ride in addition to common vehicles. Hereinafter, a moving body on which a person can ride is named a vehicle.

The input modules according to an embodiment of the present disclosure includes a surrounding environment recognition module 110, a driver behavior detection module 120, a driving information recognition module 130, a driver control input module 140, and an acceleration control permission button 150.

The acceleration control permission button 150 may be constituted with a separate button. As another example, the acceleration control permission button 150 may not be constituted with a separate button, and a corresponding function may be included in the driver control input module 140.

The surrounding environment module 110 recognizes a surrounding environment of the vehicle. The driver behavior detection module 120 detects a driver's behavior. The driving information recognition module 130 recognizes driving information (e.g., a speed, acceleration, and a steering angle) of the vehicle. The driver control input module 140 receives a driving control input from a driver.

The surrounding environment recognition module 110 recognizes a surrounding environment of the vehicle by using a sensor, such as LiDAR, radar, a camera, or a communication device, and communication. The surrounding environment recognition module 110 includes a sensor that detects a surrounding environment and surrounding situation of the vehicle. The sensor includes at least one of a camera, LiDAR, Radar, and an ultrasonic sensor. The surrounding environment recognition module 110 generates surrounding environment information by detecting a surrounding environment of the vehicle. The surrounding environment information includes surrounding environment information of the vehicle, such as a road speed limit, a driving speed of a surrounding vehicle, and parking lot information.

The driver behavior detection module 120 detects all behaviors of a driver for control of functions, such as a screen, a radio, and an air-conditioning device, through control inputs, such as a driver's handle, accelerator, brake, gear, turn indicator, and emergency light manipulations. The results of the detection of the driver's behavior are used to detect driver's driving intention.

The driving information recognition module 130 recognizes a current driving state (e.g., a speed, acceleration, a location, heading, or a steering angle) of the vehicle. A future state of the vehicle may be predicted based on the current driving state of the vehicle, which is recognized by the driving information recognition module 130.

The driver control input module 140 receives a driver's driving control input value for driving the vehicle, and receives a steering control value, acceleration and deceleration control values, and turn indication/emergency light control values. A difference between the driver behavior detection module 120 and the driver control input module 140 is described below. The driver behavior detection module 120 detects all behaviors of a driver, such as an air-conditioner manipulation, a radio manipulation, and seat adjustment, except a driving manipulation. In contrast, the driver control input module 140 identifies a behavior for driving, a steering wheel manipulation, accelerator/brake manipulations, and a turn indicator manipulation. The driver behavior detection module 120 and the driver control input module 140 may simultaneously perform the detection, and may detect the same behavior as different input values. For example, the driver behavior detection module 120 recognizes whether a driver has stepped on an accelerator pedal in the form of ON/OFF, whereas the driver control input module 140 receives how much has the accelerator pedal been stepped on in a numerical form.

An input value that is received by the driver control input module 140 is used in control. The driver control input module 140 and the driver behavior detection module 120 may be constituted with a single module, if necessary.

The acceleration control permission button 150 is a button that is pressed by a driver when the driver wants to directly perform acceleration. When the acceleration control permission button 150 is in a turn-on state, the vehicle control system 200 receives a driver's acceleration control value as an input and accelerates the vehicle. In this case, the acceleration control permission button 150 may be present as an actual physical button or a touch button, and may be constituted with a separate input command that permits acceleration control through the driver control input module 140 and that performs the same function, without a separate button.

The vehicle control system 200 detects a driver's driving intention by receiving input values from the five input modules, determines a driving mode, and performs actual vehicle control.

The vehicle control system 200 includes a driver's driving intention detection unit 210, a driving mode determination unit 220, a control calculation unit 230, a vehicle control unit 240, and an acceleration control limit unit 250.

The vehicle control system 200 according to an embodiment of the present disclosure limits a driver's control input other than some control inputs (e.g., deceleration (brake) or steering). That is, the vehicle control system disregards a corresponding control command according to presetting or adjusts timing for incorporation although a driver controls the vehicle in order to perform steering or acceleration by partially limiting a driver's control input. However, in the case of steering (handle) and deceleration (brake) control, the vehicle control system performs control so that a driver's input is directly incorporated into the vehicle. This prevents a driver's handle and brake inputs from being limited by the vehicle control system 200. It is possible to improve reliability because steering and brake operations by a driver are always possible.

According to an embodiment of the present disclosure, both steering control and brake control are possible by a driver and an autonomous driving system, but a driver's input is prioritized. That is, although a driver intentionally suddenly decelerates a vehicle, control is performed without any change by preferentially receiving the driver's intention. When an accident occurs due to the execution of the control, the driver may be basically responsible for the accident.

That is, when the driver performs steering and steps on a brake with any intention, the vehicle unconditionally responds to the driver's behavior. Accordingly, it is possible to clarify the responsibility of the driver who has not stepped on the brake when an accident occurs.

According to an embodiment of the present disclosure, in order to identify a driver's driving intention, the detection of driver's driving intention is performed. The driver's driving intention detection unit 210 detects driver's driving intention by comprehensively considering a surrounding situation of the vehicle and a driver's behavior based on the results of the recognition of the surrounding environment recognition module 110 and the driving information recognition module 130 in addition to the results of the recognition of the driver control input module 140 and the results of the recognition of the driver behavior detection module 120 for the driver's handle, accelerator, and brake. For example, when the driver greatly turns the steering wheel by 360 degrees or more, it is difficult to determine whether the driver attempts to make a U-turn or attempts a sudden left turn based on only the behavior of turning the steering wheel. The surrounding environment recognition module 110 recognizes that the vehicle is now in a lane in which a U-turn is possible. The driver's driving intention detection unit 210 determines that the driver's driving intention is a U-turn not a left turn. When the driver's driving intention is determined to be the U-turn, the vehicle control system 200 performs acceleration/deceleration control in order to handle the U-turn situation based on the identified driver's driving intention in the state in which control of the steering wheel has been set as a driver's control input.

The driver's driving intention detection unit 210 detects driver's driving intention by integrating surrounding environment information, driving information, and driver behavior detection information. According to an embodiment of the present disclosure, data in which the aforementioned information has been integrated are defined as input integration data. An actual implementation of the input integration data may be a table form or an image form.

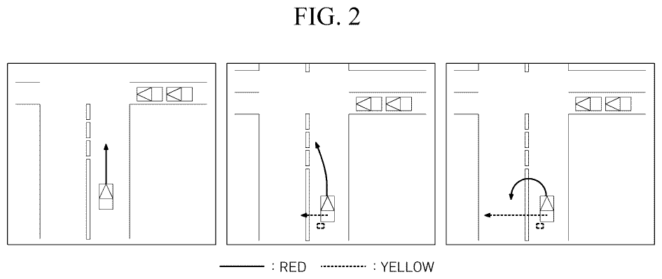

FIG. 2 illustrates input integration data according to an embodiment of the present disclosure. FIG. 2 illustrates input integration data at timing T-2 (left), timing T-1 (middle), and timing T (right).

The input integration data are data in which surrounding environment information indicated by a black line, such as a road and a surrounding vehicle, a driving path prediction value of a vehicle, which is indicated by a red arrow, a steering input indicated by a yellow arrow, and driver behavior detection information including turn indicator information indicated by a yellow rectangle have been integrated. The input integration data include a series of data for a preset time. Referring to FIG. 2, three images mean that the images were consecutively stored at three pieces of timing before predetermined timing.

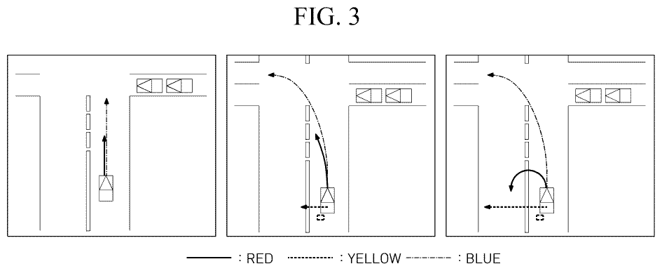

FIG. 3 illustrates input integration data and the results of the detection of driver's driving intention according to an embodiment of the present disclosure. FIG. 3 illustrates the input integration data and the results of the detection of the driver's driving intention at timing T-2 (left), timing T-1 (middle), and timing T (right).

At timing T-2, forms of a road and a surrounding vehicle are represented as surrounding environment information (black line). A driving path prediction value (red arrow) is calculated based on driving information of the vehicle and represented as straight-line driving. At timing T-2, driver behavior detection information is not indicated because separate control by a driver is not present.

The driver's driving intention detection unit 210 predicts that a driver's driving intention is straight-line driving based on input data and indicates the results of the prediction like a blue arrow.

At timing T-1, a driver's control inputs (i.e., steering input-yellow arrow and turn indicator input-yellow rectangle) are illustrated because the driver's steering wheel control input and turn indicator input are present compared to timing T-2. Accordingly, unlike in timing T-2, a path prediction value (red arrow) of the vehicle based on driving information is calculated as the path bends to the left. The driver's driving intention detection unit 210 predicts that a driver's driving intention is a left turn at the intersection based on the input integration data, and the results thereof are indicated like a blue arrow.

At timing T, the driver's steering wheel control input (yellow arrow) was great, and a turn indicator (yellow rectangle) is still turned on. Accordingly, a vehicle driving path prediction value (indicated as a red arrow) based on driving information is calculated as the vehicle is greatly turned to the extent that a U-turn is possible.

The driver's driving intention detection unit 210 predicts that the driver's driving intention is still the left turn and continuously maintains the results of the prediction for the left turn at the intersection. As a result, such a situation is a situation in which the results of the detection of the driver's driving intention are wrong.

According to an embodiment of the present disclosure, in order to identify driver intention, input integration data are generated. Reliability of the results of the detection of a driver's driving intention is improved through learning based on the input integration data.

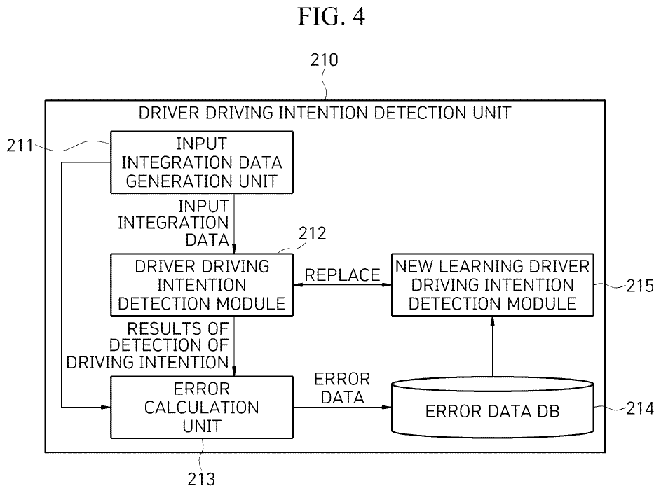

FIG. 4 illustrates the driver's driving intention detection unit according to an embodiment of the present disclosure.

The driver's driving intention detection unit 210 internally performs learning in order to detect driver's driving intention similarly to a correct answer value, by storing data in which a difference between a driving path prediction value and a driver's driving intention detection result value is a preset level or more, among the results of the detection of driver's driving intention based on collected input integration data, and using the driving path prediction value as a correct answer value and the driver's driving intention detection value as a prediction value. The driver's driving intention detection unit 210 performs learning according to a preset level or a preset period. The driver's driving intention detection unit 210 replaces a driver's driving intention detection module 212 that is now used with a new learning driver's driving intention detection module 215 so that improved detection results are derived through the new learning driver's driving intention detection module 215. The existing driver's driving intention detection module 212 starts learning again. An error calculation unit 213 outputs error data by comparing data received from an input integration data generation unit 211 and the results of the detection of driver's driving intention received from the driver's driving intention detection module 212. The error data are stored in an error data DB 214.

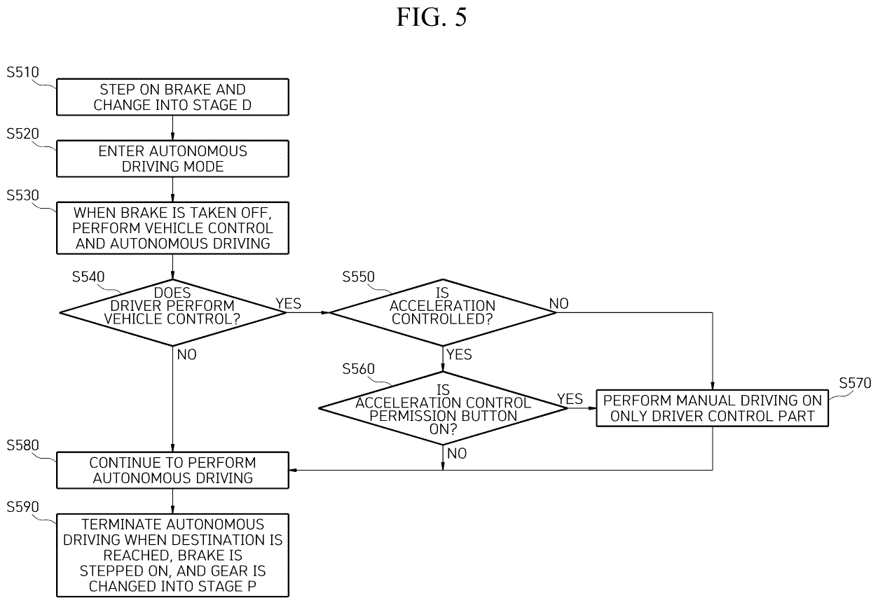

According to an embodiment of the present disclosure, when a forward or backward gear is selected based on the gear shifting of a driver, a vehicle operates in an autonomous driving mode. A sequence of autonomous driving by gear shifting or manual driving by a driver is illustrated in FIG. 5.

FIG. 5 illustrates an autonomous driving/manual driving sequence according to an embodiment of the present disclosure.

According to an embodiment of the present disclosure, if a driver does not control a vehicle, autonomous driving is continuously performed. If the driver controls other parts (e.g., steering, deceleration, and a turn indicator) other than acceleration, control is performed on only the part controlled by the driver through manual driving, and autonomous driving is continuously performed on the remaining parts.

According to an embodiment of the present disclosure, a basic setting mode is a mode in which the autonomous driving system controls acceleration and deceleration by basically disregarding a driver's acceleration input, but a driver's deceleration input is incorporated into driving. That is, although a vehicle is turned on and a driver steps on an accelerator pedal, the vehicle is not accelerated.

According to an embodiment of the present disclosure, after the autonomous driving system recognizes a surrounding situation and identifies that the surrounding situation is safe, the acceleration of a vehicle is started. Driver control (e.g., a steering wheel, a brake, and a turn indicator) other than acceleration control is immediately controlled by a driver input.

For example, when a driver turns a steering wheel during autonomous driving, the steering wheel is manually driven based on the driver's intention, but the acceleration and deceleration of a vehicle are continuously autonomously performed. Furthermore, if the driver controls only a brake, the vehicle is decelerated as much as the control, but steering control that is not controlled by the driver is still autonomously driven. If a driver's acceleration control is required, the acceleration control permission button 150 requires a separate additional manipulation for a change into ON.

According to an embodiment of the present disclosure, if a situation in which autonomous driving is no longer possible occurs due to the imperfection of the autonomous driving technology during the autonomous driving of a vehicle while adjusting acceleration and deceleration through the autonomous driving system, the manual acceleration function of a driver is controlled through the acceleration control permission button 150 as a countermeasure.

In a situation in which autonomous driving is impossible, if a driver turns on the acceleration control permission button 150, the driver is allowed to perform acceleration control unlike in the basic setting mode (i.e., a mode in which a driver's acceleration input is disregarded). Accordingly, this grants the driver the authority to control acceleration, enabling the driver to take over acceleration and drive the vehicle, thereby supporting manual driving by the driver in situations where autonomous driving is not possible.

The pre-autonomous driving and post-button input manual driving control logic according to an embodiment of the present disclosure has a sequence that is not simply different from only the sequence of the execution of pre-manual driving and upon-button input autonomous driving of a current system, and may have a great effect because the autonomous driving mode is basically used as a basic mode.

As in the embodiment of the present disclosure, if the basic mode is the autonomous driving mode, the utilization of autonomous driving can be increased, and driving learning of a driving novice can also be improved. As autonomous driving performance is improved, a danger of an accident will be further reduced, and it is possible to reduce the occurrence of an accident attributable to a driver's mistake by autonomous driving.

For example, it has been known that the accident probability of an autonomous vehicle is lower than the accident probability of a novice driver. By setting the basic mode as the autonomous driving mode and transferring the rights to driving control based on a manual button input, an effect of reducing an accident may be expected in terms of driving safety.

An embodiment of the present disclosure includes countermeasures when autonomous driving is impossible. In a situation in which autonomous driving is impossible due to the imperfection of the autonomous driving system, a vehicle stops without moving (or the vehicle performs an avoidance strategy, such as moving over to the shoulder in order to prevent an accident). At this time, a driver presses the acceleration control permission button 150 and then manipulates an accelerator pedal. Accordingly, the vehicle moves and continues to perform driving through acceleration control of the driver. Thereafter, after timing at which autonomous driving is possible again or after the driver turns off the acceleration control permission button 150, the autonomous driving system performs acceleration control, and a user's acceleration input is disregarded as in the basic setting mode.

According to an embodiment of the present disclosure, if a driver wants to control acceleration, the driver may perform the acceleration control after changing a mode into a manual driving mode by manipulating a separate button. If the driver does not turn on the acceleration control permission button 150, the driver's acceleration input is disregarded by the vehicle control system, and acceleration is performed through autonomous driving. A driver's behavior of turning on the acceleration control permission button 150 by directly manipulating a button or a switch corresponds to a secondary safety device by preventing the driver from performing acceleration control arbitrarily or a mistake and allowing the driver to explicitly represent his or her intention to perform acceleration control.

Referring to FIG. 5, when a driver steps on a brake and changes a gear into a stage D (S510) in a situation in which a vehicle has parked, the vehicle enters the autonomous driving mode (S520).

When the driver takes his or her foot off the brake, the vehicle control system performs vehicle control and autonomous driving (S530). When the driver performs a vehicle control input (S540), the vehicle control system identifies whether the vehicle control input corresponds to acceleration control (S550). When the vehicle control input corresponds to the acceleration control, the vehicle control system checks whether the acceleration control permission button 150 has been turned on (S560). When checking that the acceleration control permission button 150 has been turned on, the vehicle control system performs manual driving by incorporating a driver control part (S570). When checking that the acceleration control permission button 150 has been turned off, the vehicle control system continues to perform the autonomous driving. If driver control for a control part other than acceleration control is stopped, the vehicle control system immediately performs autonomous driving (S580). When the vehicle reaches a destination and the driver steps on a brake and change the gear into a stage P, the vehicle control system terminates the autonomous driving (S590).

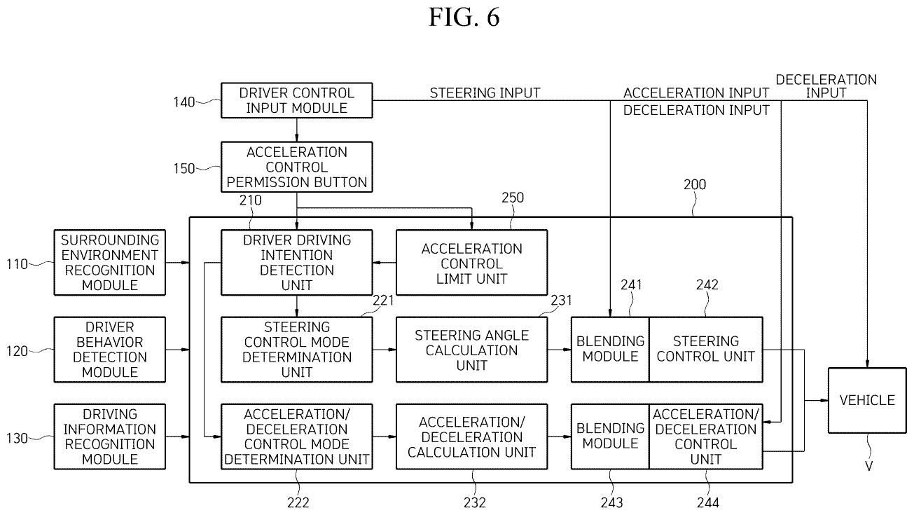

FIG. 6 illustrates a vehicle control system according to another embodiment of the present disclosure.

According to another embodiment of the present disclosure, the vehicle control system includes blending modules 241 and 243 so that the rights to control are smoothly changed by mixing a driver's control input and an input value calculated by the control calculation unit of the vehicle control system.

Several algorithms may be applied to a method of smoothly changing the rights to control by using two different inputs. For example, a convolution or fuzzy model may be applied to the method. The blending modules 241 and 243 according to an embodiment of the present disclosure apply different blending schemes and blending times depending on the type of input, such as steering/acceleration and deceleration.

According to an embodiment of the present disclosure, in the case of steering and deceleration control of a driver, a control input is directly incorporated into a vehicle without the intervention of the vehicle control system. In this case, the acceleration/deceleration control unit 244 of the vehicle control system may not require the blending modules, but may receive a deceleration control input value (brake value) of the driver and use the deceleration control input value for smooth acceleration upon acceleration control not deceleration control. The acceleration control unit and deceleration control unit of the acceleration/deceleration control unit 244 are differently used, if necessary.

According to an embodiment of the present disclosure, an error rate for the identification of driving intention is calculated based on the results of the detection of driver's driving intention. The error rate continues to be improved by performing learning through machine learning.

According to an embodiment of the present disclosure, the vehicle control system includes the blending modules in order to start autonomous driving through gear shifting without a separate button or switch and to perform a smooth change between autonomous driving by the vehicle control system and manual driving by a driver.

A vehicle according to an embodiment of the present disclosure may be similar to an autonomous vehicle, but is clearly different from the autonomous vehicle. According to an embodiment of the present disclosure, unlike in the autonomous driving technology, setting, such as a destination and a driving path, is not required. The reason for this is that a driver may directly perform driving as it comes.

Furthermore, the vehicle control system according to an embodiment of the present disclosure needs to identify a driver's acceleration intention because the driver is allowed to directly perform driving, but the direct driving of the driver is limited (i.e., because acceleration by the driver is limited), unlike in autonomous driving.

To perform autonomous driving and to identify a driver's driving intention are similar, but are different from each other. In full autonomous driving, a driver does not perform driving by fully leaving driving to a vehicle as if the driver takes a taxi. In contrast, the vehicle control system according to an embodiment of the present disclosure partially limits a driver's rights to driving, but identifies the driver's driving intention because the driver still has the rights to driving. Although the driver's driving intention detection module is not present, an autonomous driving system can perform autonomous driving. In contrast, according to an embodiment of the present disclosure, if the driver's driving intention detection module is not present, overall driving performance may be degraded because acceleration may be performed differently from a driver's intention depending on a situation.

Furthermore, according to an embodiment of the present disclosure, a driver's intention is identified by identifying the state (e.g., whether a driver dozes off or a driver's distraction) of the driver and a manipulation situation of the driver, and driving control is performed by recognizing a surrounding environment and also identifying the state of the driver. That is, control is autonomously performed by identifying a surrounding situation, the state of a vehicle, and the driving control state of a driver together. To this end, a driving control value is finally determined by receiving all of vehicle driving information, surrounding environment information, and driver behavior information.

An embodiment of the present disclosure may be applied to a situation in which some of an autonomous driving function is mounted and used in a vehicle by paying attention to a problem with a full unmanned and autonomous vehicle that is at standstill in a dilemma zone or special situation without performing autonomous driving and a lot of difficulties in releasing a fully unmanned vehicle that puts the responsibility of an accident on a manufacturer.

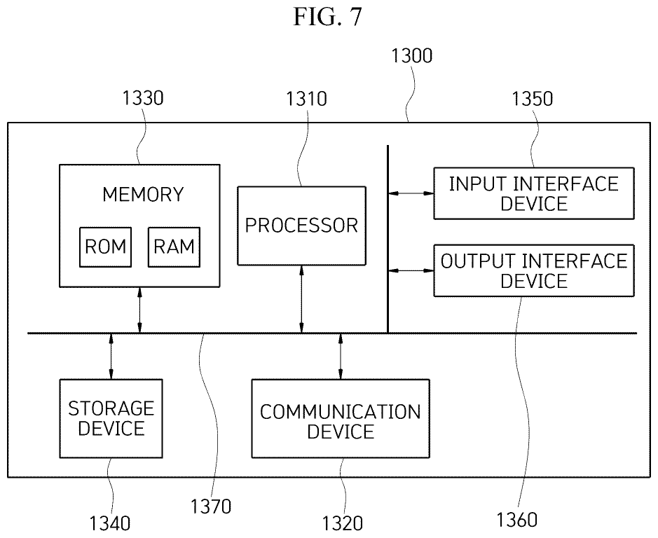

FIG. 7 is a block diagram illustrating a computer system for implementing a method according to an embodiment of the present disclosure.

Referring to FIG. 7, a computer system 1300 may include at least one of a processor 1310, memory 1330, an input interface device 1350, an output interface device 1360, and a storage device 1340 which communicate with each other through a bus 1370. The computer system 1300 may further include a communication device 1320 that is connected to a network. The processor 1310 may be a central processing unit (CPU) or may be a semiconductor device that executes an instruction stored in the memory 1330 or the storage device 1340. The memory 1330 and the storage device 1340 may each include various types of volatile or nonvolatile storage media. For example, the memory may include read only memory (ROM) and random access memory (RAM). In an embodiment of the present specification, the memory may be disposed inside or outside the processor and connected to the processor through various known means. The memory includes various types of volatile or nonvolatile storage media. For example, the memory may include ROM or RAM.

Accordingly, an embodiment of the present disclosure may be implemented as a method implemented in a computer or may be implemented as a non-transitory computer-readable medium in which a computer-executable instruction has been stored. In an embodiment, when being executed by a processor, a computer-readable instruction may perform a method according to at least one aspect of this writing.

The communication device 1320 may transmit or receive a wired signal or a wireless signal.

Furthermore, the method according to an embodiment of the present disclosure may be implemented in the form of a program instruction which may be executed through various computer means, and may be recorded on a computer-readable medium.

The computer-readable medium may include a program instruction, a data file, and a data structure alone or in combination. A program instruction recorded on the computer-readable medium may be specially designed and constructed for an embodiment of the present disclosure or may be known and available to those skilled in the computer software field. The computer-readable medium may include a hardware device configured to store and execute the program instruction. For example, the computer-readable medium may include magnetic media such as a hard disk, a floppy disk, and a magnetic tape, optical media such as CD-ROM and a DVD, magneto-optical media such as a floptical disk, ROM, RAM, and flash memory. The program instruction may include not only a machine code produced by a compiler, but a high-level language code capable of being executed by a computer through an interpreter.

The embodiments of the present disclosure have been described in detail, but the scope of rights of the present disclosure is not limited thereto. A variety of modifications and changes made by those skilled in the art using the basic concept of the present disclosure defined in the appended claims are also included in the scope of rights of the present disclosure.

What is claimed is:

1. A vehicle control system that limits a driver's driving behavior, the vehicle control system comprising:
an input interface device configured to receive a driver's control input;
memory in which a program that recognizes the driver's control input and that determines whether to incorporate results of the recognition into vehicle control has been stored; and
a processor configured to execute the program,
wherein the processor controls the driver's control input, which belongs to first classification, to be not incorporated into the vehicle control without any change and controls the driver's control input, which belongs to second classification, to be immediately incorporated into the vehicle control based on the results of the recognition.

2. The vehicle control system of claim 1, wherein the processor incorporates a control input for a deceleration input, which belongs to the second classification, into the vehicle control.

3. The vehicle control system of claim 1, wherein the processor executes an autonomous driving function with respect to a control function related to the driver's control input, which belongs to the first classification, and controls manual driving to be performed with respect to the driver's control input, which belongs to the second classification.

4. The vehicle control system of claim 1, wherein the input interface device receives surrounding environment information, driver behavior detection information, driving information, and a driver control input value.

5. The vehicle control system of claim 4, wherein the processor generates input integration data by integrating the data received by the input interface device and detects the driver's driving intention.

6. The vehicle control system of claim 5, wherein the processor performs learning based on a driving path prediction value and a driver's driving intention prediction value and updates driver's driving intention detection logic.

7. The vehicle control system of claim 1, wherein the processor performs driving control by mixing the driver's control input and a control calculation value for autonomous driving.

8. The vehicle control system of claim 1, wherein the processor incorporates the driver's control input, which belongs to the first classification, into the vehicle control when the input interface device receives an input value for a manual driving command.

9. A vehicle control method being performed by a vehicle control system that limits a driver's driving behavior and comprising steps of:
(a) receiving and classifying a driver's control input; and
(b) incorporating the driver's control input into manual driving or performing autonomous driving by disregarding the driver's control input based on results of the classification in the step (a).

10. The vehicle control method of claim 9, wherein the step (a) comprises additionally collecting driving information and surrounding environment information in addition to the driver's control input.

11. The vehicle control method of claim 10, wherein the step (b) comprises generating input integration data by integrating the information collected in the step (a) and detecting the driver's driving intention.

12. The vehicle control method of claim 11, wherein the step (b) comprises performing learning based on driving path prediction results and results of the detection of the driver's driving intention and updating driver's driving intention detection logic.

13. The vehicle control method of claim 9, wherein the step (b) comprises disregarding the driver's control input for an acceleration input and incorporating the driver's control input for a deceleration input into driving.

14. The vehicle control method of claim 13, wherein the step (b) comprises incorporating the driver's control input for the acceleration input into the driving when receiving a separate command for manual driving from a user.

15. The vehicle control method of claim 9, wherein the step (b) comprises performing driving control by mixing the driver's control input and a control calculation value for autonomous driving.

16. A vehicle apparatus comprising:
an input module configured to receive surrounding environment recognition information, driver behavior detection information, driving information, and driver control input information; and
a vehicle control system configured to control autonomous driving and manual driving based on the information received by the input module and to limit a driver's driving behavior based on a previously classified category.

17. The vehicle apparatus of claim 16, wherein the vehicle control system incorporates the driver's control input for deceleration control into driving without any change and controls the autonomous driving by disregarding the driver's control input for acceleration control.

18. The vehicle apparatus of claim 17, wherein the vehicle control system incorporates the acceleration control into the driving when receiving a separate user command for the manual driving.

19. The vehicle apparatus of claim 16, wherein the vehicle control system detects the driver's driving intention based on the information received by the input module, performs learning by using driving path prediction results and driver's driving intention prediction results, and updates driver's driving intention detection logic.

20. The vehicle apparatus of claim 16, wherein the vehicle control system performs driving control by mixing the driver's control input and a control calculation value for the autonomous driving.
